(19) United States
(12) Patent Application Publication
(10) Pub. No.: US 2005/0158048 A1
(43) Pub. Date: Jul. 21, 2005

(54) Optical line terminal for managing link status of optical network units and gigabit ethernet passive optical network employing same

(76) Inventors: Whan-Jin Sung, Suwon-si (KR); Shin-Hee Won, Seoul (KR); Tae-Sung Park, Yongin-si (KR); Do-Young Joung, Suwon-si (KR); Se-Kang Park, Seongnam-si (KR); Jun-Sung An, Suwon-si (KR); Soon-Ho Jang, Seongnam-si (KR); Dong-Il Seo, Suwon-si (KR)

Correspondence Address: CHA & REITER, LLC, 210 ROUTE 4 EAST STE 103, PARAMUS, NJ, 07652, US

(21) Appl. No.: 10/869,439

(22) Filed: Jun. 16, 2004

(30) Foreign Application Priority Data
Jan. 20, 2004 (KR) 2004-4177

(51) Int. Cl. H04J 14/00

(52) U.S. Cl. 398/66

(57) ABSTRACT

A system and method for managing link status in Gigabit Ethernet passive optical network (GE-PON) units (ONUs) is disclosed. The GE-PON comprises one or more ONUs allocated data transmission periods, respectively. Each of the ONUs sends a report signal and a data signal in a corresponding one of the allocated data transmission periods. The report signal contains a signal to request allocation of a bandwidth for data signal transmission in a next window period. The GE-PON further comprises an optical splitter having its one side connected with the ONUs and its other side connected with at least one optical communication channel. The optical splitter switches an input signal to a desired destination. The GE-PON further comprises an optical line terminal (OLT) for determining whether the report signal is received, identifying a specific one of the ONUs having sent the report signal when the report signal is received, determining whether the data signal is received from the specific ONU in a specific one of the data transmission periods allocated to the specific ONU, and discriminating and managing a link status of the specific ONU in accordance with the determination made.

### CLAIM OF PRIORITY

This application claims priority, pursuant to 35 U.S.C. §119, to that patent application entitled “OPTICAL LINE TERMINAL FOR MANAGING LINK STATUSES OF OPTICAL NETWORK UNITS AND GIGABIT ETHERNET PASSIVE OPTICAL NETWORK EMPLOYING THE SAME,” filed in the Korean Intellectual Property Office on Jan. 20, 2004 and assigned Serial No. 2004-4177, the contents of which are hereby incorporated by reference.

### BACKGROUND OF THE INVENTION

1. Field of the Invention

The present invention relates to a Gigabit Ethernet passive optical networks (GE-PON) consisting of one optical line terminal (OLT) provided at the service provider side and a plurality of optical network units (ONUs) provided at the user side, and more particularly to a method for managing link status between the OLT and the ONUs.

2. Description of the Related Art

Nowadays, the expansion of public networks, such as wireless networks, and very high-speed communication networks, enables mass data to be shared online. It is the current reality that the offline sharing of data through low-priced mass storage media, such as compact discs (CDs) or digital versatile discs (DVDs), is also used very widely. Therefore, users are provided with numerous types of data shared online and offline.

A passive optical network (PON) is a communication network system that transfers signals to end users over an optical cable network. The typical PON consists of an optical line terminal (OLT) installed in a communication company in communication with a plurality of optical network units (ONUs) installed near subscribers. Typically, an OLT can support a maximum of 32 ONUs.

The PON can provide a bandwidth of 1 Gbps in the upstream and downstream directions in one stand-alone system, and this bandwidth can be allocated to a plurality of PON users. The PON may also be used as a trunk between a large-scale system, such as a cable TV system, and an Ethernet network for a neighboring building or home employing a coaxial cable.

In the conventional PON, an OLT transmits a signal to an ONU via an optical cable, referred to as downstream transmission. The ONU receives the signal transmitted from the OLT, processes it in a predetermined manner and then transfers the processed result to an end user. The ONU, which, in this case, is a transfer system for the service subscriber side, is an optical network termination unit that provides a service interface to the end user.

The ONU accommodates FTTC (Fiber To The Curb), FTTB (Fiber To The Building), FTTF (Fiber To The Floor), FTTH (Fiber To The Home), FTTO (Fiber To The Office) methods of transmission. Thus, the ONU is implemented to provide high service accessibility to the subscriber. The ONU functions to interconnect a cable that is connected with the subscriber to transmit an analog signal downstream and optical equipment that is connected with the OLT to transmit and receive optical signals. As a result, the ONU performs an optical/electrical conversion operation to convert an optical signal from the OLT into an electrical signal, in a downstream transmission and transmit the converted electrical signal to the subscriber, and an electrical/optical conversion operation to convert an electrical signal from the subscriber into an optical signal and transmit the converted optical signal to the OLT, in an upstream transmission.

FIG. 1 illustrates a conventional downstream data transmission structure of a Gigabit Ethernet passive optical network (GE-PON), and FIG. 2 illustrates a conventional upstream data transmission structure of the Gigabit Ethernet passive optical network. As shown in FIGS. 1 and 2, the Gigabit Ethernet passive optical network (GE-PON) has a structure where one OLT 10 is connected with a plurality of ONUs 20, 22 and 24 in a tree form via an optical splitter 15. The GE-PON is an optical access network that is more inexpensive and efficient than an AON (Activity-On-Node) network.

An earlier version of the GE-PON, an asynchronous transfer mode passive optical network (ATM-PON) has been developed and standardized. The ATM-PON transmits ATM cells in the form of a block with a desired size in the upstream or downstream direction. Another PON, an Ethernet passive optical network (E-PON), transmits packets of different sizes.

Downstream data transmission is now described with reference to FIG. 1. In the downstream transmission, the OLT 10 broadcasts data to be transmitted to the ONUs 20, 22 and 24. The optical splitter 15 receives the data broadcast from the OLT 10 and transmits the received data to each of the ONUs 20, 22 and 24. The ONUs 20, 22 and 24, each detect data to be transferred to a corresponding one of users 30, 32 and 34 from the data transmitted from the optical splitter 15 and transfers only the detected data to the corresponding user 30, 32 or 34.

Upstream data transmission is now described with reference to FIG. 2. In the upstream transmission, data from the users 30, 32 and 34 are transferred to the ONUs 20, 22 and 24, respectively. The ONUs 20, 22 and 24 transmit the data from the users 30, 32 and 34 to the optical splitter 15 according to a transmission permission convention from the OLT 10, respectively. The ONUs 20, 22 and 24 each transmit, upstream, the received data in a time slot set in a TDM (Time Division Multiplexing) manner. Therefore, no data collision resulting from the upstream data transmission occurs in optical splitter 15.

OLT 10 monitors a link status of each of the ONUs 20, 22 and 24 to notify a network manager of a change in a connection, e.g., a registration, with each of the ONUs 20, 22 and 24. As a result, the network manager checks the link status of each of the ONUs 20, 22 and 24, monitored and provided by the OLT 10, and performs a network task corresponding to the change.

FIG. 3 is a block diagram illustrating an architecture for the monitoring of link status of ONUs by an OLT in a GE-PON. In this illustrative example, OLT 40 is connected with a maximum of 32 ONUs 60, 62, . . . , 66 and 68 in a tree form via an optical splitter 50. The OLT 40 is provided at the service provider side and the ONUs 60, 62, 66 and 68 are provided at the user side.

OLT 40 includes an optical transmitter 44 for transmitting an optical signal to the ONUs 60, 62, 66 and 68 via the optical splitter 50, an optical receiver 46 for receiving optical signals transmitted from the ONUs 60, 62, 66 and 68 via the optical splitter 50, and a network management unit 42 for managing the transmission and reception of optical signals. The network management unit 42 is a network management group that performs operation, administration and maintenance (OAM) functions of the network.

OLT 40 monitors the link status of the ONUs 60, 62, 66 and 68 using a conventional link status monitoring method based on receive signal power loss employed in a point to point architecture.

However, since the GE-PON has a point to multipoint architecture using the optical splitter 50, the conventional link status monitoring method employed in the point to point architecture has a disadvantage in that it cannot accurately discriminate among and determine the link status of each of the ONUs 60, 62, 66 and 68.

In conventional monitoring methods, the ONUs 60, 62, 66 and 68 each turn on a laser diode and maintain a standby mode, in order to transmit data in a time slot allocated by the OLT 40. That is, even while any one of the ONUs 60, 62, 66 and 68 transmits data, the others must always turn on the laser diodes and maintain the standby mode, such as a power save mode. However, OLT 40 receives a signal corresponding to data actually transmitted from any one of the ONUs 60, 62, 66 and 68 and signals transmitted from the other ONUs in the standby mode. As a result, OLT 40 cannot accurately recognize the link status of the ONUs 60, 62, 66 and 68 from the signals transmitted.

FIG. 4 represents a timing diagram illustrating a conventional method for managing link status on the basis of receive signal power losses based on the transmission laser power levels of the ONUs. As shown, a window size 70 is a period in which ONUs registered in an OLT transmit signals in time slots allocated by the OLT. The ONUs each change the operation mode of a laser diode from a standby mode to a data transmission mode in a corresponding one of the allocated time slots. As a result, the ONUs each raise the transmission power level of the laser diode to a desired level before a data transmission period 72, 74 or 76 in the corresponding time slot and then maintain the desired power level for the respective data transmission period 72, 74 or 76. The ONUs transmit the maintained power levels in the data transmission periods 72, 74 and 76, respectively.

OLT 40 receives the signals transmitted from the ONUs in the data transmission periods 72, 74 and 76 allocated to respective ONUs. For the signal transmission of these ONUs, the power level of the laser diode of each of the ONUs is raised to the desired level before the data transmission period and lowered to a level corresponding to the standby mode after the data transmission period. For this reason, the laser diodes of the ONUs have power loss periods 82, 84 and 86 before and after the data transmission periods 72, 74 and 76.

However, the OLT also receives signals with the power level corresponding to the standby mode from two neighbor ones of the ONUs in each of the power loss periods 82, 84 and 86, so it cannot accurately discriminate the link statuses of the ONUs.

### SUMMARY OF THE INVENTION

The present invention has been made in view of the above problems, and it is an object of the present invention to provide a device that is capable of more accurately managing link status of optical network units (ONUs) and a Gigabit Ethernet passive optical network (GE-PON) employing the same.

In accordance with an aspect of the present invention, the above and other objects can be accomplished by the provision of an optical line terminal (OLT) for managing link status of optical network units (ONUs) connected therewith, comprising an optical transmitter for transmitting to the ONUs information about data transmission periods allocated to the respective ONUs, an optical receiver for receiving a report signal and data signal sent from each of the ONUs in each of the allocated data transmission periods, the report signal containing bandwidth allocation request information, a link status discriminator for determining whether the report signal is received by the optical receiver, identifying a specific one of the ONUs having sent the report signal if the report signal is received, determining whether the data signal is sent from the specific ONU and received by the optical receiver in a specific one of the data transmission periods allocated to the specific ONU, and discriminating a link status of the specific ONU in accordance with the determination and a network management unit for performing an operation based on the link status of the specific ONU discriminated by the link status discriminator.

The link status discriminator is adapted to identify the specific ONU having sent the report signal by an LLID (Logical Link Identification) associated with a specific ONU contained in the report signal and discriminate a type of the received signal by option code information contained in the report signal, the option code information being indicative of the type of the received signal.

The link status discriminator may determine the link status of the specific ONU to be normal if the report signal is received at a start time of the specific data transmission period and the data signal is received from the specific ONU for the specific data transmission period.

The link status discriminator may determine that power loss has occurred in the specific ONU if the report signal is received at the start time of the specific data transmission period and the data signal is received from the specific ONU for only part of the specific data transmission period. In this case, the link status discriminator may determine the link status of the specific ONU to be abnormal if no report signal from the specific ONU is received in a next window period.

Preferably, the link status discriminator is adapted to determine that an error has occurred in an operation of any one of the ONUs corresponding to a certain one of the data transmission periods if no report signal is received at a start time of the certain data transmission period and the data signal is received for the certain data transmission period.

The link status discriminator may determine that an error has occurred in at least one of an operation and link status of any one of the ONUs corresponding to a certain one of the data transmission periods if no report signal is received at a start time of the certain data transmission period and no data signal is received for the certain data transmission period.

In accordance with another aspect of the present invention, there is provided a Gigabit Ethernet passive optical network (GE-PON) comprising one or more ONUs allocated data transmission periods, respectively, each of the ONUs sending a report signal and a data signal in a corresponding one of the allocated data transmission periods, the report signal containing a signal to request allocation of a bandwidth for data signal transmission in a next window period, an optical splitter having its one side connected with the ONUs and its other side connected with at least one optical communication channel, the optical splitter switching an input signal to a desired destination, and an OLT for determining whether the report signal is received, identifying a specific one of the ONUs having sent the report signal if the report signal is received, determining whether the data signal is received from the specific ONU in a specific one of the data transmission periods allocated to the specific ONU, and discriminating and managing a link status of the specific ONU in accordance with the determination.

In a feature of the present invention, an OLT identifies a report signal sending ONU on the basis of a report signal that is sent in a data transmission period allocated in the previous window period, determines whether there is data received from the report signal sending ONU in the data transmission period, discriminates a link status of that ONU in accordance with the determination, and performs an operation corresponding to a result of the discrimination. Therefore, the OLT can more accurately discriminate and manage link statuses of ONUs registered therein.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a downstream data transmission structure of a Gigabit Ethernet passive optical network (GE-PON);

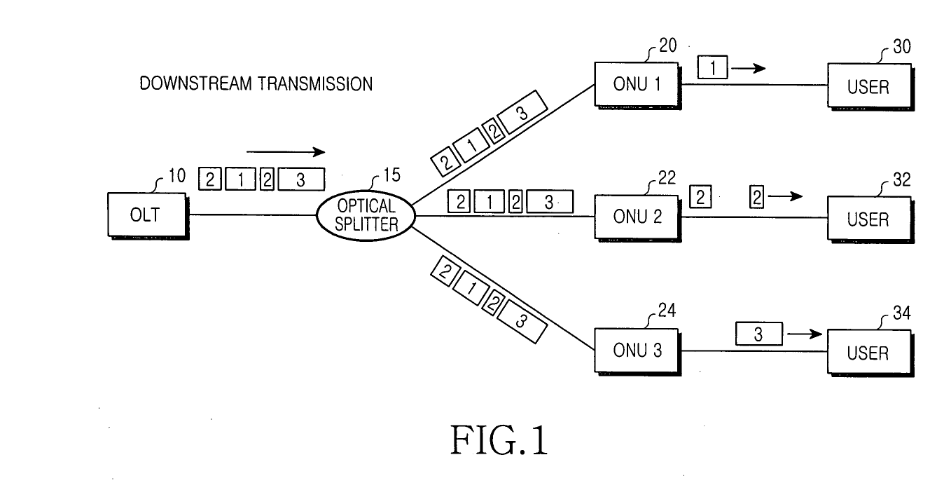

FIG. 2 is a view showing an upstream data transmission structure of the GE-PON;

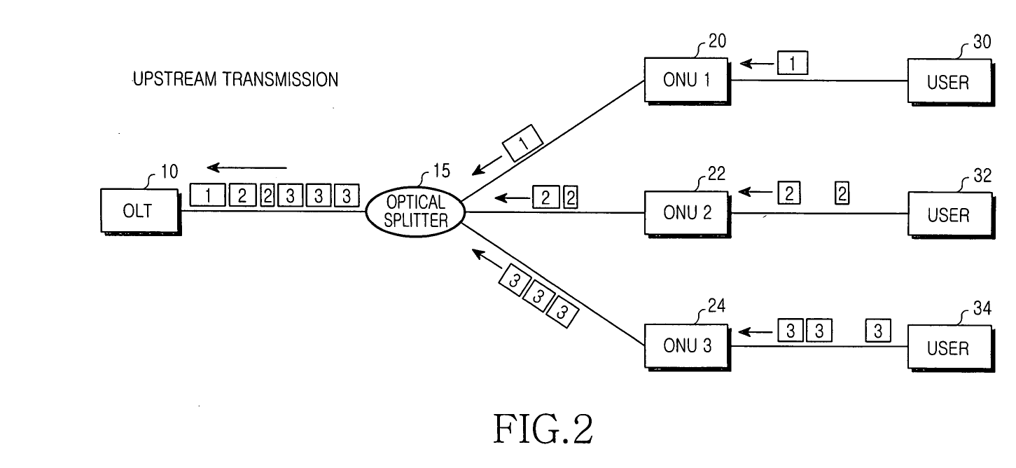

FIG. 3 is a block diagram showing an architecture for the monitoring of link statuses of ONUs by an OLT in a GE-PON;

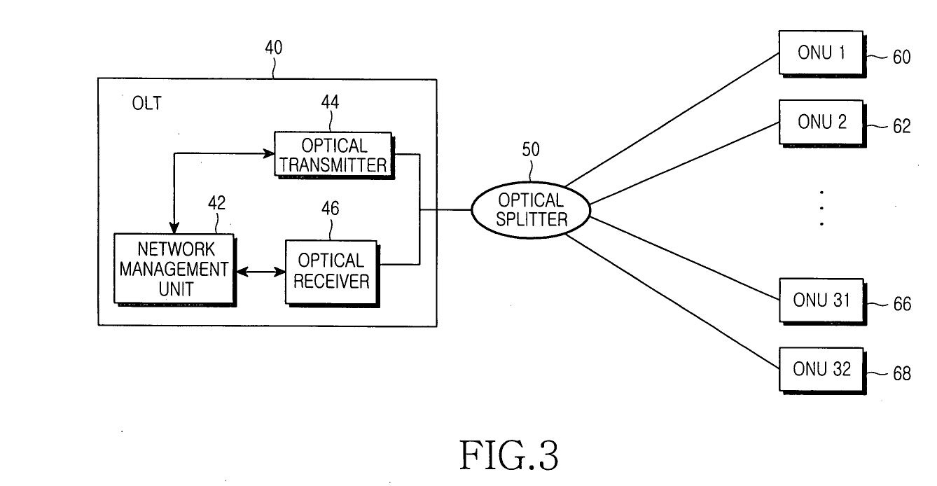

FIG. 4 is a timing diagram illustrating a conventional method for managing link statuses of ONUs on the basis of receive signal power losses based on the transmission laser power levels of the ONUs;

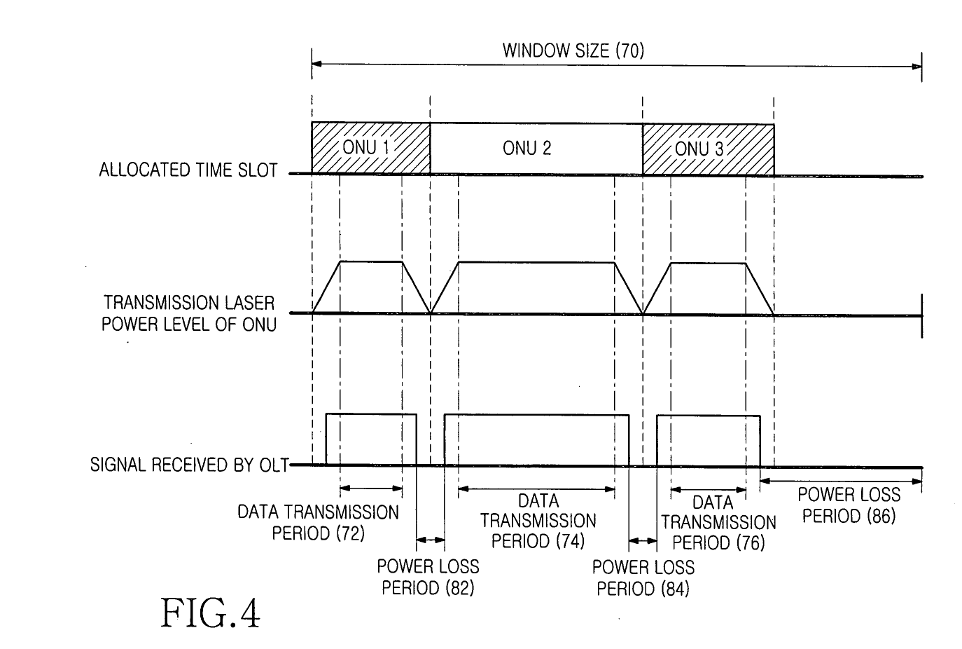

FIG. 5 is a chart illustrating a conventional procedure for communication with an OLT by an ONU;

FIG. 6 is a block diagram showing an embodiment of a GE-PON for managing link statuses of ONUs, according to the present invention;

FIG. 7 is a timing diagram illustrating a method for discriminating the link status of ONUs shown in FIG. 6 according to the present invention; and

FIG. 8 is a view showing the format of a report signal which is transmitted from an ONU according to the present invention.

### DETAILED DESCRIPTION OF THE INVENTION

Embodiments of the present invention will now be described in detail with reference to the annexed drawings. In the drawings, the same or similar elements may be denoted by the same reference numerals even though they are depicted in different drawings. In the following description, a variety of specific elements such as constituent elements of various concrete circuits are shown. The description of such elements has been made only for a better understanding of the present invention. Those skilled in the art will appreciate that the present invention can be implemented without using the above-mentioned specific elements. For purposes of clarity, detailed description of known functions and configurations incorporated herein are omitted when it makes the subject matter of the present invention unclear.

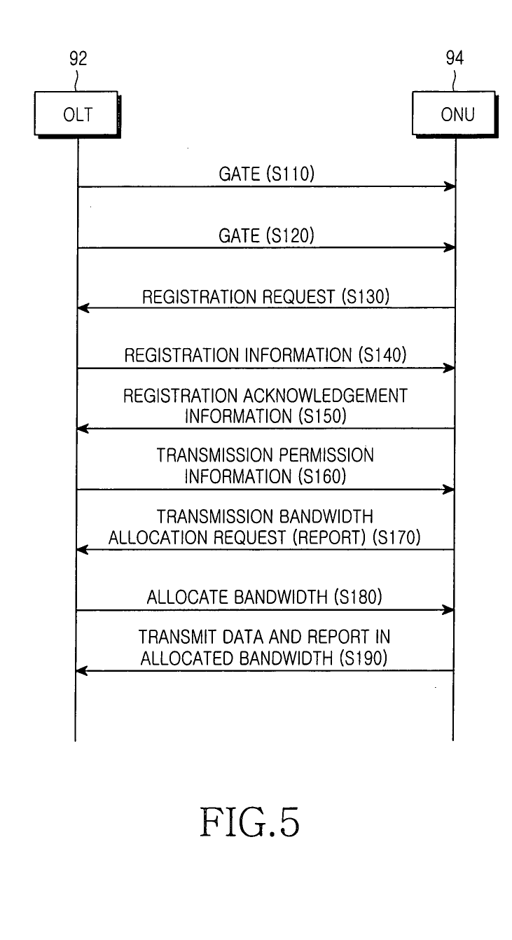

FIG. 5 is a chart illustrating a conventional procedure for communication with an OLT by an ONU. Upon power-up, the OLT, denoted by the reference numeral 92, broadcasts a gate signal to all ONUs connected via an optical communication medium to discover them (S110). The OLT 92 sends the gate signal to the ONUs at intervals of a predetermined time until it receives a registration request signal (S120). In response to the gate signal sent from the OLT 92, the ONU, denoted by the reference numeral 94, sends the registration request signal to the OLT 92 (S130).

When the OLT 92 receives the registration request signal sent from the ONU 94, then it registers the ONU 94 and allocates an LLID (Logical Link IDentification) thereto. The OLT 92 then sends information about the registration of the ONU 94 and information about the LLID allocated thereto to the ONU 94 (S140). Upon receiving the registration information and LLID information, the ONU 94 sends registration acknowledgement information to the OLT 92 (S150). When the OLT 92 receives the registration acknowledgement information from the ONU 94, it sends information permitting transmission of a data transmission request signal (S160) to the ONU 94. At this time, the transmission permission information contains information about a time slot allocated to the ONU 94. The ONU 94 receives the transmission permission information and sends a bandwidth allocation request signal to the OLT 92 to request it to allocate a bandwidth for data transmission (S170). Here, the bandwidth allocation request signal is called a report signal. This report signal contains the LLID allocated to the ONU 94 and information about the type of the signal being sent.

When the OLT 92 receives the report signal sent from the ONU 94, it allocates the data transmission bandwidth to the ONU 94 (S180). The ONU 94 transmits data in the allocated transmission bandwidth (S190). At this time, the ONU 94 sends a report signal to the OLT 92 to request it to allocate a bandwidth for data transmission in the next window period. This report signal contains the LLID allocated to the ONU 94 and information about the type of the signal being sent.

In the present invention, the OLT monitors a link status of the ONU using a bandwidth for data transmission allocated to the ONU in the previous window period and a report message sent from the ONU in the allocated bandwidth.

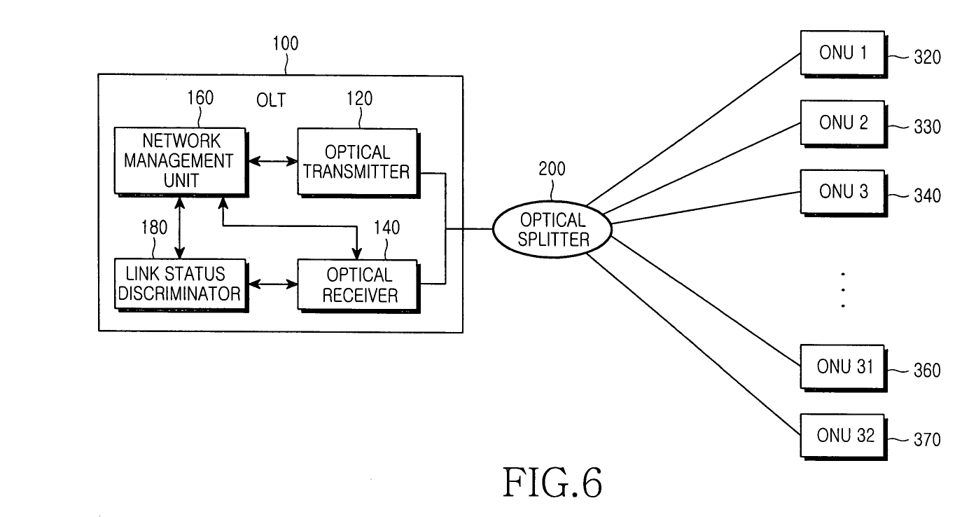

FIG. 6 is a block diagram showing an embodiment of a Gigabit Ethernet passive optical network (GE-PON) for managing link statuses of ONUs, according to the present invention. As shown, the GE-PON has a structure where one OLT 100 is connected with a maximum of 32 ONUs 320, 330, 340, . . . , 360 and 370 in a tree form via an optical splitter 200. The optical splitter 200 is adapted to switch signals received from the OLT 100 and the ONUs 320, 330, 340, 360 and 370 to corresponding destinations. The OLT 100 includes an optical transmitter 120, an optical receiver 140, a network management unit 160, and a link status discriminator 180. The optical transmitter 120 acts to transmit an optical signal to the ONUs 320, 330, 340, 360 and 370 via the optical splitter 200. The optical receiver 140 acts to receive optical signals transmitted from the ONUs 320, 330, 340, 360 and 370 via the optical splitter 200. The network management unit 160 acts to manage the transmission and reception of optical signals and operations based on the link statuses of the ONUs 320, 330, 340, 360 and 370. The link status discriminator 180 is adapted to discriminate the link status of ONUs 320, 330, 340, 360 and 370 on the basis of the signals received by the optical receiver 140 and output the discrimination results to the network management unit 160.

The present embodiment will now be described with reference to one of the ONUs 320, 330, 340, 360 and 370 as an example. When the ONU 320, for example, completes a registration procedure with the OLT 100, it sends a report signal requesting the allocation of a bandwidth for data transmission, to the OLT 100, in every window period (See FIG. 5). The OLT 100 allocates a bandwidth for data transmission by the ONU 320 in the next window period. The OLT 100 sends a gate signal containing information about the allocated transmission bandwidth to the ONU 320. Here, the transmission bandwidth is a period in which the ONU 320 is permitted to transmit data in the next window. In this connection, the transmission bandwidth information contains a bandwidth start time and bandwidth length.

The link status discriminator 180 discriminates a link status of the ONU 320 on the basis of the start time of a transmission bandwidth allocated to the ONU 320 in the previous window period and a report signal received from the ONU 320 in the allocated transmission bandwidth. More specifically, the link status discriminator 180 checks the LLID contained in a report signal to determine which one of the ONUs 320, 330, 340, 360 and 370 has sent the report signal. The link status discriminator 180 also checks signal type information contained in a received signal to determine whether the received signal is a report signal. When the received signal is a report signal, the link status discriminator 180 determines which one of the ONUs has sent the report signal, by checking an LLID contained in the report signal. Where the report signal sending ONU is determined to be the same as one allocated the data transmission bandwidth (period), the link status discriminator 180 determines that data received in the allocated period has been sent from the allocated ONU.

Therefore, in the case where data is received from the report signal sending ONU in the allocated data transmission period, the link status discriminator 180 determines the link status of that ONU to be normal.

However, if either no data is received from the report signal sending ONU in the allocated data transmission period, only data is received in the allocated period with no report signal received, or any signal is not received in the allocated period, the link status discriminator 180 determines the link status of that ONU to be abnormal.

The link status discriminator 180 transfers the discrimination information about the link status of each ONUs to the network management unit 160. The network management unit 160 receives the link status discrimination information from the link status discriminator 180 and provides a visual or aural indication of the received information so that a network manager can confirm that information.

As described above, the OLT identifies a report signal sending ONU on the basis of a report signal that is sent in a data transmission period allocated in the previous window period, determines whether there is data received from the report signal sending ONU in the data transmission period, discriminates a link status of that ONU in accordance with the determination, and performs an operation corresponding to a result of the discrimination. Therefore, the OLT can more accurately discriminate and manage link statuses of ONUs registered therein.

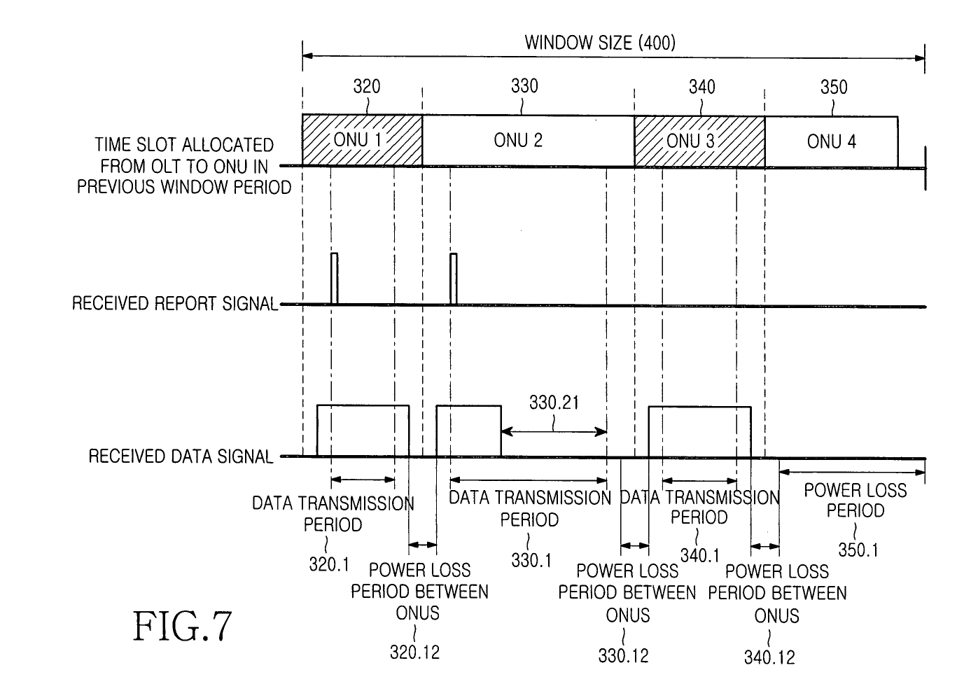

FIG. 7 is a timing diagram illustrating a method for discriminating the link status of the ONUs shown in FIG. 6 according to the invention. In this case, each of the ONUs changes the operation mode of a laser diode from a standby mode to a data transmission mode in a corresponding time slots allocated by the OLT. As a result, the ONUs selectively raise the transmission power level of the laser diode to a desired level before a data transmission period 320.1, 330.1, 340.1 and 350.1 in the corresponding time slot, which was allocated in the previous window period, and maintains the desired power level for the data transmission period 320.1, 330.1, 340.1 and 350.1. The ONUs transmit signals to the OLT with the maintained power levels in the respective data transmission periods 320.1, 330.1, 340.1 and 350.1.

The ONUs each send a report signal to the OLT at the start time of an allocated data transmission period 320.1, 330.1, 340.1 and 350.1. Thereafter, each ONUs transmits data during the allocated data transmission period 320.1, 330.1, 340.1 and 350.1.

For example, in the allocated data transmission period 320.1 of the ONU1 320, the OLT 100 receives a report signal sent from the ONU1 320 at the start time of the data transmission period a allocated in the previous window period and a data signal transmitted from the ONU1 320 for the data transmission period a. As a result, the OLT 100 determines the link status of the ONU1 320 allocated the data transmission period 3201.1 to be normal, i.e., expected report and expected data received. In the data transmission period 330.1 allocated to ONU2 330, the OLT 100 receives a report signal sent from the ONU2 330 at the start time of the data transmission period 330.1 allocated in the previous window period. At this time, if the OLT 100 receives a data signal transmitted from the ONU2 330 for a limited period of the data transmission period 330.1, it determines the remaining duration, 330.21, of the data transmission period 330.1 to be a power loss period 330.12 of the ONU2 330. In this case, if there is no report signal received from the ONU2 330 in the next window period, the OLT 100 determines the link status of the ONU2 330 to be abnormal.

In the data transmission period 340.1 allocated in the previous window period to ONU3 340, the OLT 100 receives no report signal from the ONU3 340 at the start time of the data transmission period 340.1. In this case, the OLT 100 recognizes that there is no power loss in the ONU3 340 since a data signal is received for the data transmission period 340.1, but there is a problem in the ONU3 340. If the received data signal is not a normal data frame, the OLT 100 determines that the received data signal has been transmitted under the influence of optical interference of the ONU3 340 with another ONU. In this case, the OLT 100 searches for an ONU with the same phenomenon as that of the ONU3 340. If the OLT 100 detects ONUs with the same phenomenon, it can recognize the ONUs as those having caused interference in the data signal received in the allocated data transmission period 340.1.

FIG. 7 also illustrates that in a data transmission period 350.1, allocated to the ONU4 350, there is neither a report signal nor a data signal received from the ONU4 350. In this case, the OLT 100 determines that a problem has occurred in the operation and/or the link with of the ONU4 350.

As further shown in FIG. 7, the power loss periods 320.12, 330.12, 340.12 are present between the data transmission periods allocated to the ONUs. Since there are no report signal and data signal received in the data transmission period allocated to the ONU4 350, this data transmission period becomes a power loss period 350.12 of the ONU4 350.

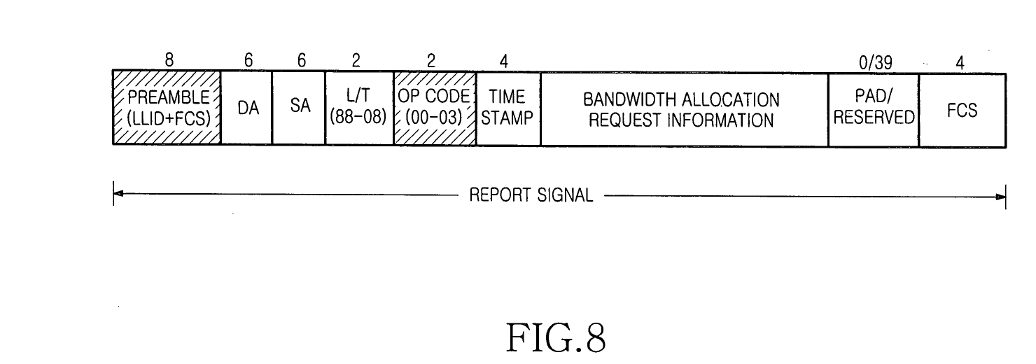

FIG. 8 illustrates an exemplary format of a report signal which is transmitted from an ONU. As shown in this drawing, the report signal has an LLID of a corresponding ONU, and an option (OP) code indicative of a signal type. The LLID is contained in a preamble. Information indicating that the sent signal is a report signal is contained in an option code. An option code corresponding to the report signal is “00-03”.

Accordingly, the OLT 100 identifies a signal sending ONU on the basis of an LLID contained in a preamble of a signal sent therefrom and determines on the basis of an option code of the sent signal whether the sent signal is a report signal.

According to the present invention, an OLT identifies a report signal sending ONU on the basis of a report signal that is sent in a data transmission period allocated in the previous window period, determines whether there is data received from the report signal sending ONU in the data transmission period, discriminates a link status of that ONU in accordance with the determination, and performs an operation corresponding to a result of the discrimination. Therefore, the OLT can more accurately discriminate and manage link status of ONUs registered therein.

Although the embodiments of the present invention have been disclosed for illustrative purposes, those skilled in the art will appreciate that various modifications, additions and substitutions are possible, without departing from the scope and spirit of the invention as disclosed in the accompanying claims.

1. An optical line terminal (OLT) for managing link status of optical network units (ONUs), comprising:
an optical transmitter for transmitting to said ONUs information regarding data transmission periods allocated to said ONUs during a specified window period;
an optical receiver for receiving a report signal and data signal from each of said ONUs in each of said allocated data transmission periods, said report signal containing bandwidth allocation request information;
a link status discriminator for determining whether said report signal is received by said optical receiver, identifying a specific one of said ONUs having sent said report signal if said report signal is received, determining whether said data signal is sent from said identified ONU said data transmission periods allocated to said identified ONU, and determining a link status of said specific ONU in accordance with the combined received signal and data signal determination; and
a network management unit for performing an operation based on said determined link status of said specific ONU.

2. The OLT as set forth in claim 1, wherein said link status discriminator is adapted to identify said specific ONU having sent said report signal by an LLID (Logical Link IDentification) associated with said specific ONU contained in said report signal and to determine a type of the received signal by an option code information contained in said report signal, said option code information being indicative of the type of the received signal.

3. The OLT as set forth in claim 2, wherein said link status discriminator is adapted to determine the link status of said identified ONU to be normal if the report signal is received at a start time of the allocated data transmission period and the data signal is received from said identified ONU for the allocated data transmission period.

4. The OLT as set forth in claim 3, wherein said link status discriminator is adapted to determine that power loss has occurred in said identified ONU if said report signal is received at the start time of the allocated data transmission period and the data signal is received from said identified ONU for only a part of the allocated data transmission period, and to determine the link status of said identified ONU to be abnormal if no report signal is received in a next window period.

5. The OLT as set forth in claim 3, wherein said link status discriminator is adapted to determine that an error has occurred in an operation of a corresponding one of said ONUs if no report signal is received at a start time of the allocated data transmission period and the data signal is received for the allocated data transmission period.

6. The OLT as set forth in claim 3, wherein said link status discriminator is adapted to determine that an error has occurred in at least one of an operation and link status of a corresponding one of said ONUs if no report signal is received at a start time of the allocated data transmission period and no data signal is received for the allocated data transmission period.

7. A Gigabit Ethernet passive optical network (GE-PON) comprising:
one or more ONUs, each having allocated a data transmission period within a window period, each of said ONUs operable to send at least a report signal and a data signal said report signal containing a signal to request allocation of a bandwidth for data signal transmission in a next window period;
an optical splitter having its one side connected with said ONUs and its other side connected with at least one optical communication channel, said optical splitter switching an input signal to a desired destination; and
an OLT for determining whether said report signal is received, identifying a specific one of said ONUs having sent said report signal if said report signal is received, determining whether said data signal is received from said identified ONU in an allocated data transmission period, and determining and managing a link status of said identified ONU in accordance with the received signal and data signal determination.

8. The GE-PON as set forth in claim 7, wherein said OLT includes:
an optical transmitter for transmitting, to said ONUs, information regarding said data transmission period allocated to said ONUs;
an optical receiver for receiving said report signal and data signal sent from each of said ONUs in each of said allocated data transmission periods;
a link status discriminator for determining whether said report signal is received by said optical receiver, identifying a specific ONU having sent said report signal if said report signal is received, determining whether said data signal is sent from said identified ONU and received by said optical receiver in said allocated data transmission period, and determining the link status of said specific ONU; and
a network management unit for performing an operation based on said link status of said identified ONU.

9. The GE-PON as set forth in claim 8, wherein said link status discriminator is adapted to identify said specific ONU having sent said report signal by an LLID associated with said ONU, said LLID contained in said report signal, and determine a type of the received signal by an option code information contained in said report signal, said option code information being indicative of the type of the received signal.

10. The GE-PON as set forth in claim 8, wherein said link status discriminator is adapted to determine the link status of said allocated ONU to be normal if said report signal is received at a start time of said specific data transmission period and said data signal is received from said identified ONU for the allocated data transmission period.

11. A method for determining network link status comprising the step of:
determining whether a report signal is received during a specified period, said report signal being transmitted by one of a plurality of network devices allocated the specified period;
determining whether a data signal is received during said specified period: and
determining a link status of the network device in accordance with the combined determination of said received signal and said data signal, wherein the link status is determined to be normal when said report signal and said data signal are received as expected.

12. The method as claimed in claim 11, wherein the link status is abnormal when the received report signal is not associated with a network device allocated the specified time period.

13. The method as claimed in claim 11, wherein the link status is abnormal when the data signal is for a duration less than the specified time period.

14. The method as claimed in claim 11, wherein the link status is abnormal when the no report signal is received and a data signal is received.

15. The method as claimed in claim 11, wherein the link status is abnormal when no report signal and no data signal are received.

16. The method as claimed in claim 11, wherein the report signal is expected at the start of the specified time period and the data signal for the remainder of the specified time period.

17. The method as claimed in claim 11, wherein the report signal includes an identifier associated with each network device.

18. The method as claimed in claim 11, wherein the report signal and data signal include an option code indicative of the type of signal received.
